(19) United States
(12) Patent Application Publication
(10) Pub. No.: US 2017/0305022 A1
(43) Pub. Date: Oct. 26, 2017

(54) RAZOR ASSEMBLY

(71) Applicants: Nelson BAMUNDAGA, West Hollywood, CA (US); LFNB, LLC, West Hollywood, CA (US)

(72) Inventor: Nelson BAMUNDAGA, West Hollywood, CA (US)

(73) Assignee: LFNB, LLC, West Hollywood, CA (US)

(21) Appl. No.: 15/513,513

(22) PCT Filed: Sep. 23, 2015
(86) PCT No.: PCT/US2015/051733

§ 371 Date: Mar. 22, 2017

Related U.S. Application Data
(63) Continuation of application No. 14/494,850, filed on Sep. 24, 2014, now abandoned.

(51) Int. Cl. B26B 21/06; B26B 21/40

(52) U.S. Cl. CPC B26B 21/06; B26B 21/4031; B26B 21/4006; B26B 21/4018

(57) ABSTRACT

A razor assembly is provided. The razor assembly includes a housing having front and back elongated members wherein each elongated member includes a plurality of panels. The razor assembly further includes at least one blade arranged in between and parallel to the front and back elongated members and at least one blade guard perpendicular and connected to the front and back elongated members with the at least one guard having embedded at least one blade at a predefined distance, and a release bay defined by the area between the back and front elongated members of the housing and the at least one blade.

### CROSS-REFERENCE TO RELATED APPLICATIONS

This application claims the benefit of U.S. application Ser. No. 14/494,850, filed on Sep. 24, 2014, the entire contents of which are incorporated by reference herein.

### BACKGROUND

### 1) Field of the Invention

The present invention relates generally to a razor assembly. More particularly, the invention relates to a razor assembly involving non-powered wet shaving devices for people who have pseudofolliculitis barbae.

### 2) Discussion of the Related Art

The overall feature of a razor is that it must provide a close shave. However, certain skin and hair types develop “shaving bumps” or pseudofolliculitis barbae (PFB) in certain areas of the beard when a close shave is affected. PFB is most common on the male face, but it can also happen on other parts of the body where hair is shaved or plucked, especially areas where hair is curly and the skin is sensitive.

After a hair has been shaved, it begins to grow back. Curly hair tends to curl into the skin instead of straight out the follicle, leading to an inflammation reaction. PFB can make the skin look itchy and red, and in some cases, it can even look like pimples. These inflamed papules or pustules can form especially if the area becomes infected. This is especially problematic for some men who have naturally coarse or tightly curling thick hair. Curly hair increases the likelihood of PFB. If left untreated over time, this can cause keloid scarring in the beard area.

PFB can further be divided into two types of ingrown hairs: transfollicular and extrafollicular. The extrafollicular hair is a hair that has exited the follicle and reentered the skin. The transfollicular hair never exits the follicle, but because of its naturally curly nature curls back into the follicle causing fluid build-up and irritation. This can occur where obliquely exiting hairs are cut tangentially too close to the skin surface causing them to re-enter into the skin where they may occasion inflammation.

In shaving close, certain skin and hair types experience or develop inflammation due to re-entry into the skin of the closely shaved hairs. Prior art razors have failed to address the concerns of people who have certain skin and hair types where PFB is common. Accordingly, it would be desirable to provide a razor assembly directed to overcoming the inflammation problems discussed herein.

### BRIEF DESCRIPTION OF THE DRAWINGS

FIG. 1 is a front angled perspective view of an embodiment of a razor assembly.

FIG. 2 is a front perspective view of an embodiment of the razor assembly.

FIG. 3 is a top view of an embodiment of the razor assembly.

FIG. 4 is a bottom perspective view of an embodiment of the razor assembly.

FIG. 5 is a side cross-sectional view of an embodiment of the razor assembly.

FIG. 6 is a front cross-sectional view of an embodiment of the razor assembly.

FIG. 7 is a bottom view of an embodiment of the razor assembly.

FIG. 8 is a side view of an embodiment of the razor assembly.

### DETAILED DESCRIPTION OF THE INVENTION

The invention is designed to accommodate the difficulties encountered in shaving for those with the PFB or other skin condition. Specifically, individuals suffering from PFB desire to have a close shave but need a razor that will not inflame the condition. Inflammation of this condition occurs when hairs are cut too short, such that the sharp, cut edge of the hair becomes engaged by and is re-directed downwards into the dermis. At this point, the hair thus burrows back beneath the surface of the skin, rather than emerging from the skin and growing externally in the normal manner. The inevitable result is ingrowth of the hair accompanied by inflammation of the skin. It is therefore preferable to prevent the development of any such inflammation.

The present invention addresses the problems outlined above, however is also applicable to all skin circumstances where shaving bumps or other skin eruptions or imperfections militate against an excessively close shave. Non-limiting examples of other conditions that may benefit from the present invention include non-facial pseudofolliculitis, acne, rashes, rosacea, dermatitis (including atopic, seborrheic, radiation, and others), psoriasis, and lupus erythematosus. In an embodiment of the invention, the razor assembly 100 generally includes a housing 102 employing a blade 116 with defined sharpness characteristics, at least one blade guard 118 and a release bay 128.

As will be explained more fully below, the structure of the razor assembly 100, functions in such a way that when shaving, that is, when the housing 102 is run across the surface of the skin with the blade sharp edge out front cutting through the hair shaft, the components and the dimensions and relationship of the components provide a close shave without inflaming the skin of those with PFB.

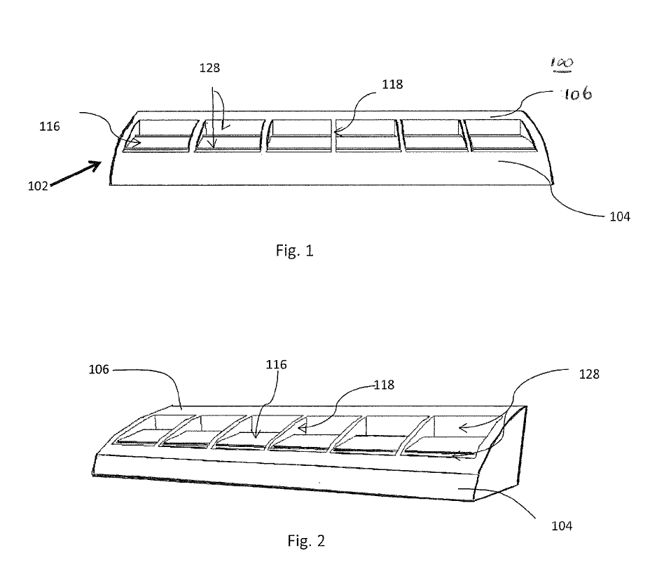

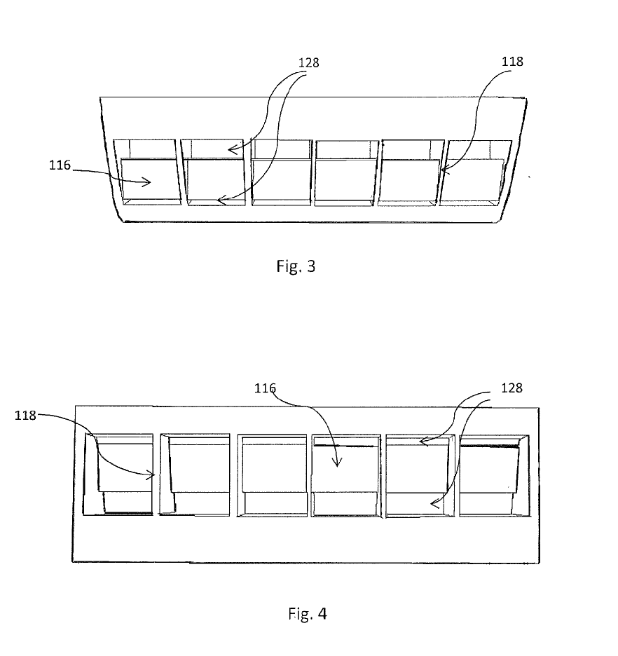

FIGS. 1 and 2 illustrate a front perspective of the housing 102. The housing 102 includes the front and back elongated members, 104 and 106, respectively. The housing 102 can be comprised of a variety of materials but are typically molded from a number of different plastic resins including polystyrene, polypropylene, and phenyleneoxide based resins as well as elastomeric compounds. These resins are taken in pellet form and are melted and molded into the razor components through a combination of extrusion and injection molding techniques.

The front and back elongated members, 104 and 106, respectively, in an embodiment, can be comprised of a plurality of panels, with specific panels being arched or curved to follow the contour of the overall structure of the razor assembly 100. In an embodiment, a single panel is curved or arched or is otherwise an “arched panel,” with respect to the remaining panels. The curve or arch allows for a smoother and cleaner shave. In another embodiment, a single panel can be angled with respect to the remaining panels. In another embodiment, the panels of the elongated members, 104 and 106, form the shape of a triangle. In another embodiment, the elongated members, 104 and/or 106 can include a moisturizing strip. In another embodiment, the elongated members 104 and/or 106 can include a lubricating strip. In another embodiment, the elongated members 104 and/or 106 can include textured surfaces. The textured surfaces can help lift the individual hairs from the surface of the skin. In another embodiment, the elongated members 104 and/or 106 include both a lubricating strip and a textured surface. In another embodiment, the elongated members 104 and/or 106 include both a moisturizing strip and a textures surface.

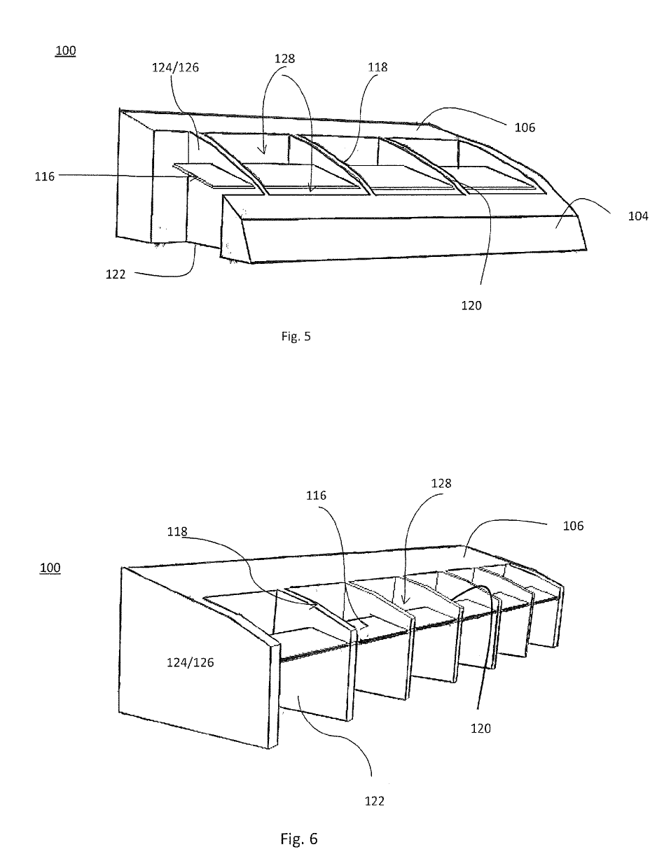

FIGS. 3 and 4 illustrate a blade 116, or razor blade, with defined sharpness characteristics. As described herein, the at least one blade 116 is embedded into the blade guard 118 (described below) at predefined distances. The razor blade 116 includes a front and back edge with a top and bottom surface. The at least one blade 116 can be made from stainless steel, however other materials, such as ceramic or single crystal materials, are within the scope of this invention. The razor blade is typically 0.05 mm-0.15 mm thick. One of skill in the art will recognize this as being readily flexible.

FIGS. 5 and 6 illustrate a cross-section of the razor assembly 100, specifically the at least one blade guard 118. In an embodiment, the razor assembly 100 includes at least one blade guard 118. The at least one blade guard 118 is connected to the front elongated member 104 and back elongated member 106 of the housing 102. The blade guard 118 is comprised of a top portion 120, which connects with the skin, a bottom portion 122 and first and second side portions, 124 and 126.

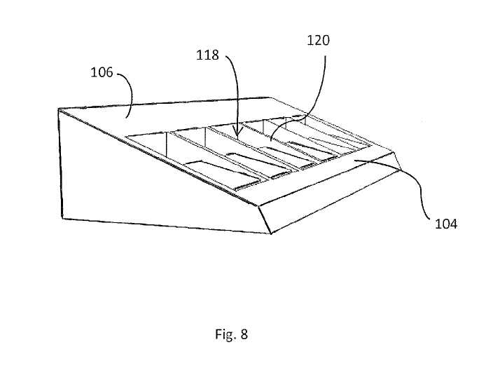

In an embodiment, the top portion 120 of the at least one blade guard 118 is curved. Specifically, the distance from the top portion 120 to the embedded at least one blade 116 increases when going from the front to the back elongated member, 104 and 106. The increasing distance between the skin and the guard as you move from front to back serves to create the desired angle of blade to skin. This is made more effective by the embedding of the at least one blade 116 being positioned directly behind or underneath the top portion 120. In another embodiment, the top portion 120 is straight (illustrated in FIG. 8), with the distance from front to back creating and angle between 20 and 45 degrees with respect to the at least one blade 116. In an embodiment, the distance from the front edge of the at least one blade to the top portion 120 is between 0.5 mm and 1 mm.

The at least one blade guard 118 can be comprised of similar materials as that of the housing 102, namely, plastic resins including polystyrene, polypropylene, and phenyleneoxide based resins as well as elastomeric compounds.

In an embodiment, a plurality of blade guards 118 can be arranged running perpendicularly with the housing 102 and at least one blade 116. In another embodiment, the guard count is between the range of 5 and 15, including outermost blade guards 118 located at each end. Generally, an increase in guard count will decrease the amount of skin in direct contact with the blade between guards. This is a function of length of the razor assembly, thus otherwise varying with dimensions of other component parts of the razor assembly 100. Generally, an increase in blade guards 118 provides an increase in protection against PFB.

In an embodiment, the distance between the blade guards 118 will depend on the number of blade guards 118 present with respect to particular dimensions, are equidistant. However, in another embodiment, the distances may vary between blade guards 118.

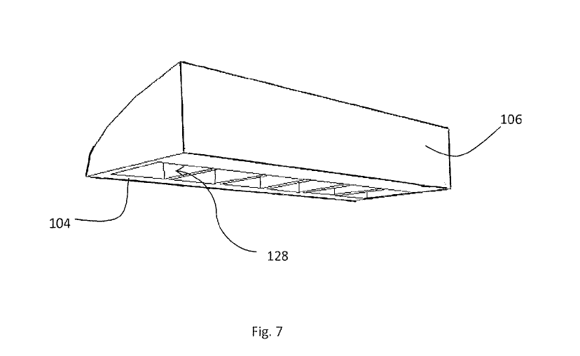

FIGS. 3, 4 and 7 illustrate a release bay 128. The release by 128, in an embodiment, includes the area between blade guards 118 and the front and back elongated members, 104 and 106, minus the area occupied by the at least one blade 116. The release bay 128 is partially defined by the distance between sharp front edge of the at least one blade 116 and the front elongated member 104, of which would be in direct contact with the skin. Increasing distance would provide an increase in the protection against PFD. In an embodiment, this distance is between 0.5 mm and 1 mm.

An advantage of the invention is the housing 102 and the plurality of blade guards 118 molded within. The at least one blade guard 118 generally sits in front of and perpendicular to the at least one blade 116. The depth of the at least one blade guard 118 or distance between the top portion 120 of the blade guard 118 touching the skin, and the at least one blade 116, keeps the at least one blade 116 edge further away from the skin than most traditional non-powered razors.

The blade guards 118 are molded to provide a predetermined length cut of the hair shaft. The cut is close enough to have the appearance of a close shave to the naked eye but far enough away that it will eliminate or dramatically reduce chances of PFB. The various thicknesses of the at least one blade guard 118 in the housing 102 is desirable for a razor adopted to those suffering from PFB because of the extreme sensitivity of the face and is designed to minimize nicks and cuts associated with the continuous exposure of a blade cutting edge.

The razor assembly can be attached to a handle to facilitate shaving. In one embodiment, the handle is attached in a fixed or non-moving manner. In another embodiment, the handle attaches in a moveable manner that allows the razor assembly to pivot. In one embodiment, the razor assembly pivots up to 180 degrees top to bottom and/or side to side. In another embodiment, the razor assembly pivots up to 90 degrees top to bottom and/or side to side. In another embodiment, the razor assembly pivots up to 45 degrees top to bottom and/or side to side. In another embodiment, the handle is detachable. In another embodiment, the handle is non-detachable. In another embodiment, the handle is attached using a proprietary mechanism. In another embodiment, the handle is ergonomically shaped. In another embodiment, the handle has a vibrating mechanism. In another embodiment, the handle is textured or patterned to improve grip.

The overall advantage of the invention is to provide a razor assembly which cuts a high percentage of facial hair and provides a cut hair surface which is substantially smooth and therefore resists re-penetration into the face. This is due to the special relationship of the blade 116 and least one blade guard 118. The razor assembly 100 rides over the face at a distance which does not slice open the characteristic bumps associated with PFB condition. The blade does not provide the extremely close shave usually desired but does provide an acceptable shave with maximum comfort and minimum ingrown hair resulting. In sum, the shave is close enough to have the appearance of a close shave but far enough away that it will eliminate or dramatically reduce the chances of PFB.

Although the foregoing invention has been described in some detail for purposes of clarity, it will be apparent that certain changes and modifications may be made without departing from the principles of the present invention. It should be noted that there are many alternative ways of implementing both the processes and apparatuses of the present invention. Accordingly, the present embodiments are to be considered as illustrative and not restrictive, and the invention is not to be limited to the specific details given herein.

Further, it will be understood that those skilled in the art, both now and in the future, may make various improvements and enhancements which fall within the scope of the claims which follow. These claims should be construed to maintain the proper protection for the invention first described.

1. A razor assembly comprising:
a housing having front and back elongated members wherein each elongated member includes a plurality of panels;
at least one blade comprising a front and back edge and a top and bottom surface, arranged in between and parallel to the front and back elongated members;
at least one blade guard perpendicular and connected to the front and back elongated members, having a top portion, bottom portion, and first and second side portions, the at least one blade guard having embedded at least one blade through the first and second side portions at a predefined distance; and
a release bay defined by the area between the back and front elongated members of the housing and the at least one blade.

2. The razor assembly of claim 1 wherein the front elongated member has at least one curved panel.

3. The razor assembly of claim 1 wherein the back elongated member has at least one curved panel.

4. The razor assembly of claim 1 wherein the plurality of panels of each elongated member is in the form of a triangle.

5. The razor assembly of claim 1 wherein the at least one blade is between 0.5 mm and 1 mm from the front elongated member.

6. The razor assembly of claim 1 wherein the at least one blade guard is a plurality.

7. The razor assembly of claim 6 wherein the plurality of blade guards are evenly spaced.

8. The razor assembly of claim 1 wherein the at least one blade guard number between 5 and 15.

9. The razor assembly of claim 1 wherein the top portion is curved.

10. The razor assembly of claim 1 wherein the top portion is straight.

11. The razor assembly of claim 10 wherein the top portion forms a 20 to 45 degree angle with respect to the at least one blade.

12. The razor assembly of claim 1 wherein the vertical distance from the front edge of the at least one blade to the top portion of the at least one blade guard is between 0.5 mm and 1 mm.

13. The razor assembly of claim 1 wherein the housing is plastic.

14. The razor assembly of claim 1 wherein the at least one blade guards is plastic.

15. The razor assembly of claim 1 wherein the blade is stainless steel, ceramic, or single crystal material.

16. The razor assembly of claim 1 further comprising a handle.

17. A razor for use on inflamed or irritated skin, the razor comprising the razor assembly of claim 1.

18. The razor of claim 17 wherein the skin inflammation or irritation is due to pseudofolliculitis barbae, non-facial pseudofolliculitis, shaving bumps, skin eruptions, acne, rashes, rosacea, seborrhoeic dermatitis, atopic dermatitis, psoriasis, or lupus erythematosus.

19. A method for reducing or preventing skin inflammation or irritation due to shaving, the method comprising the step of shaving the skin with a razor comprising the razor assembly of claim 1.

20. The method of claim 19 wherein the skin inflammation or irritation is due to pseudofolliculitis barbae, non-facial pseudofolliculitis, shaving bumps, skin eruptions, acne, rashes, rosacea, seborrhoeic dermatitis, atopic dermatitis, psoriasis, or lupus erythematosus.
